(19) United States
(12) Patent Application Publication
(10) Pub. No.: US 2026/0338480 A1
(43) Pub. Date: Oct. 29, 2026

(54) AIR AND LIQUID COOLING DEVICE FOR RACING DRIVERS

(71) Applicant: Haiyan Zhou, Shenzhen (CN)

(72) Inventor: Haiyan Zhou, Shenzhen (CN)

(21) Appl. No.: 19/700,191

(22) Filed: Jun. 6, 2026

(30) Foreign Application Priority Data
Feb. 25, 2026 (CN) 202620222877.3

(51) Int. Cl. F28D 1/053; F28D 21/00

(52) U.S. Cl. CPC F28D 1/05366; F28D 2021/0031

(57) ABSTRACT

An air and liquid cooling device for racing drivers includes a metal housing, a compressor, a condenser, a liquid reservoir, a first water pump, a liquid circulation radiator, a blower, and a second water pump. A blower is mounted on one side of the liquid circulation radiator. Based on the refrigeration principle, liquid in the liquid reservoir is chilled to a low temperature. The first water pump circulates the cold liquid through an external garment, the second water pump circulates the cold liquid through the liquid circulation radiator, and the blower delivers cold air from the liquid circulation radiator into a helmet. The air and liquid cooling device provides better thermal protection for the core body and head of a driver while the driver focuses on racing competition in a hot environment.

### BACKGROUND OF THE INVENTION

### 1. Technical Field

The present disclosure relates to the technical field of thermal comfort management of racing drivers, in particular to an air and liquid cooling device for racing drivers.

### 2. Description of Related Art

As we all know, racing drivers will wear racing suits for safety when driving racing cars at a high speed. However, because the racing suits are designed to be very thick and body-hugging for better safety protection, the racing drivers will feel very hot when wearing the racing suits in summer. In view of this, existing racing cars are equipped with cooling devices, which on one hand, provide cold air to helmets worn by racing drivers, and on the other hand, cyclically deliver cold water to the racing suits.

At present, existing cooling devices for racing drivers adopt either water cooling or air cooling, and at least two cooling devices, which are respectively a water cooling device and an air cooling device, are needed to provide water cooling and air cooling at the same time, which will obviously occupy more space of the racing cars; due to the limited space of the racing cars, the application of the water cooling device and the air cooling device to the racing cars will lead to inconvenience.

### BRIEF SUMMARY OF THE INVENTION

An objective of the present disclosure is to provide an air and liquid cooling device for racing drivers to overcome the defects that existing cooling devices for racing drivers adopt either water cooling or air cooling and at least two cooling devices, which are respectively a water cooling device and an air cooling device, are needed to provide water cooling and air cooling at the same time, which will obviously occupy more space of the racing cars, and that the application of the water cooling device and the air cooling device to the racing cars will lead to inconvenience due to the limited space of the racing cars.

To solve the above technical problems, the present disclosure provides the following technical solution: an air and liquid cooling device for racing drivers includes a metal housing.

A compressor, a condenser, a liquid reservoir, a first water pump, a liquid circulation radiator and a second water pump are arranged in the metal housing; an outlet of the compressor is connected to an inlet of the condenser by means of a copper tube, a condenser fan is mounted on a side of the condenser, and an outlet of the condenser is connected to an inlet of the compressor by means of a copper tube.

Two water inlets and two water outlets are formed in the liquid reservoir, one of the two water outlets in the liquid reservoir communicates with a water inlet tube of the first water pump, a water outlet tube of the first water pump extends to an outside, the other water outlet in the liquid reservoir communicates with a water inlet tube of the second water pump, a water outlet tube of the second water pump communicates with the liquid circulation radiator, and a water outlet tube of the liquid circulation radiator communicates with one of the two water inlets in the liquid reservoir.

A blower is mounted on a refrigeration surface of the liquid circulation radiator; a mainboard, an exhaust port and a water filling port are arranged at a top of the metal housing; the mainboard includes a compressor control panel, a liquid cooling control panel and an air cooling control panel; an air outlet of the blower communicates with the exhaust port; the water filling port communicates with a top of the liquid reservoir.

In use, based on the refrigeration principle of the compressor, liquid in the liquid reservoir is chilled to a low temperature; the low-temperature liquid is pumped from the liquid reservoir by the first water pump and the second water pump; the first water pump directly transports the low-temperature liquid to a liquid-cooled suit worn by a racing driver to realize water cooling; the second water pump transports the low-temperature liquid to the liquid circulation radiator, flowing air around is cooled by the liquid circulation radiator, and the blower sucks air from the refrigeration surface of the liquid circulation radiator and delivers the cold air into a helmet to realize air cooling.

Further, the compressor control panel is electrically connected to the compressor, the liquid cooling control panel is electrically connected to the first water pump, and the air cooling control panel is electrically connected to the second water pump and the blower.

Further, the metal housing is made from aluminum alloy.

Further, a power interface and a data interface are arranged on two sides of the metal housing respectively.

Further, a base plate is arranged at a bottom of the metal housing, bolts are arranged on the base plate, and a stationary base is fixedly mounted on the base plate by means of the bolts.

Further, the copper tubes between the condenser and the compressor penetrate through the liquid reservoir.

Further, an air inlet of the blower corresponds to the liquid circulation radiator.

The air and liquid cooling device for racing drivers provided by the present disclosure has the following advantages: based on the refrigeration principle of the compressor, liquid in the liquid reservoir is chilled to a low temperature; meanwhile, the first water pump and the second water pump are used for diversion, part of the liquid in the liquid reservoir flows into the liquid circulation radiator, cold air is produced by the blower and delivered into a helmet, and the other part of the liquid in the liquid reservoir flows into a liquid-cooled suit to realize water cooling, such that the cooling device integrates air cooling and water cooling, thereby being more suitable for racing drivers.

### BRIEF DESCRIPTION OF THE SEVERAL VIEWS OF THE DRAWING

FIG. 1 is a schematic structural diagram according to the present disclosure.

FIG. 2 is a schematic back structural diagram according to the present disclosure.

FIG. 3 is a first schematic internal structural diagram of a metal housing according to the present disclosure.

FIG. 4 is a second schematic internal structural diagram of the metal housing according to the present disclosure.

FIG. 5 is a third schematic internal structural diagram of the metal housing according to the present disclosure.

Reference signs: 1, metal housing; 2, mainboard; 3, compressor; 4, condenser; 5, base plate; 6, stationary base; 7, bolt; 8, liquid reservoir; 9, first water pump; 10, liquid circulation radiator; 11, second water pump; 12, blower; 13, condenser fan; 14, exhaust port; 15, water filling port.

### DETAILED DESCRIPTION OF THE INVENTION

The technical solutions in the embodiments of the present disclosure are clearly and completely described below in conjunction with accompanying drawings of the embodiments. Obviously, the embodiments described below are merely illustrative ones, and are not all possible ones of the present disclosure. All other embodiments obtained by those ordinarily skilled in the art on the basis of the following ones without creative labor should fall within the protection scope of the present disclosure.

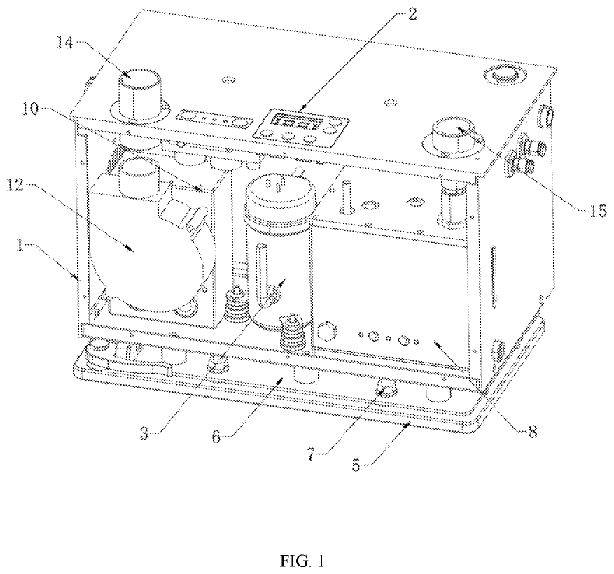

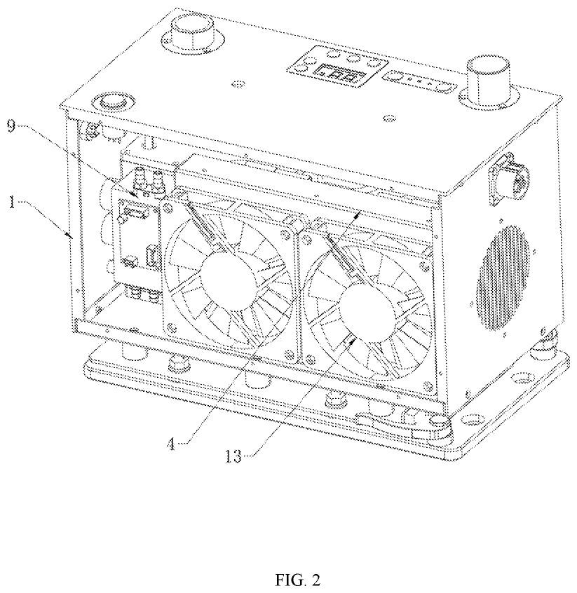

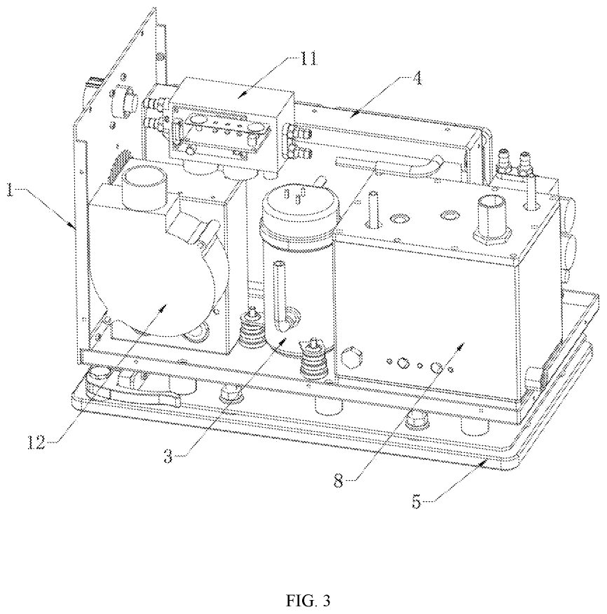

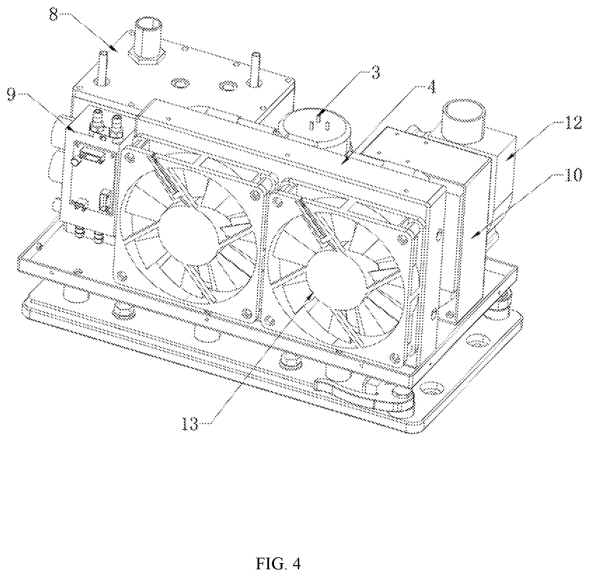

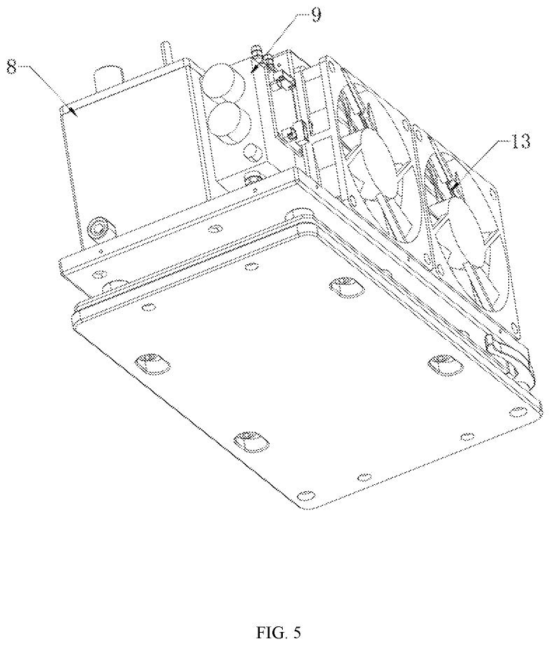

Referring to FIGS. 1-5, in one embodiment of the present disclosure, an air and liquid cooling device for racing drivers includes a metal housing 1.

A compressor 3, a condenser 4, a liquid reservoir 8, a first water pump 9, a liquid circulation radiator 10 and a second water pump 11 are arranged in the metal housing 1. An outlet of the compressor 3 is connected to an inlet of the condenser 4 by means of a copper tube. Condenser fans 13 are mounted on one side of the condenser 4. An outlet of the condenser 4 is connected to an inlet of the compressor 3 by means of a copper tube. The copper tubes between the condenser 4 and the compressor 3 penetrate through the liquid reservoir 8.

In use, the liquid reservoir 8 is filled with liquid, and the copper tubes between the condenser 4 and the compressor 3 are in direct contact with the liquid in the liquid reservoir 8; based on the refrigeration principle of the compressor 3, the compressor 3 compresses a refrigerant and then transports the refrigerant to the condenser 4, and the refrigerant is cooled by the condenser 4 together with the condenser fans 13 to form a low-temperature refrigerant, which flows through the liquid reservoir 8 to transmit the low temperature to the liquid in the liquid reservoir 8; then, the refrigerant flows back into the compressor 3, such that the liquid in the liquid reservoir 8 is cooled.

Referring to FIGS. 1-5, two water inlets and two water outlets are formed in the liquid reservoir 8, one of the two water outlets in the liquid reservoir 8 communicates with a water inlet tube of the first water pump 9, a water outlet tube of the first water pump 9 extends to the outside, the other water outlet in the liquid reservoir 8 communicates with a water inlet tube of the second water pump 11, a water outlet tube of the second water pump 11 communicates with the liquid circulation radiator 10, and a water outlet tube of the liquid circulation radiator 10 communicates with one of the two water inlets in the liquid reservoir 8.

In use, the water outlet tube of the first water pump 9 is connected to an external liquid-cooled suit, the first water pump 9 and the second water pump 11 are used for diversion, part of the liquid in the liquid reservoir 8 flows into the liquid circulation radiator 10 by means of the second water pump 11, and the other part of the liquid in the liquid reservoir 8 flows into the external liquid-cooled suit by means of the first pump 9 to realize water cooling, such that the cooling device integrates air cooling and water cooling, thereby being more suitable for racing drivers.

Referring to FIGS. 1-5, a blower 12 is mounted on a refrigeration surface of the liquid circulation radiator 10; a mainboard 2, an exhaust port 14 and a water filling port 15 are arranged at the top of the metal housing 1; the mainboard 2 includes a compressor control panel, a liquid cooling control panel and an air cooling control panel; an air outlet of the blower 12 communicates with the exhaust port 14, the water filling port 15 communicates with the top of the liquid reservoir 8, and an air inlet of the blower 12 corresponds to the liquid circulation radiator 10; the compressor control panel is electrically connected to the compressor 3, the liquid cooling control panel is electrically connected to the first water pump 9, and the air cooling control panel is electrically connected to the second water pump 11 and the blower 12.

In use, the liquid flows from the liquid reservoir 8 into the liquid circulation radiator 10, cold air is produced by the blower 12, and the mainboard 2 includes the compressor control panel, the liquid cooling control panel and the air cooling control panel, which respectively control the compressor 3, the first water pump 9 and the second water pump 11 to operate synergistically with the blower 12.

Referring to FIGS. 1-5, the metal housing 1 is made from aluminum alloy, a power interface and a data interface are arranged on two sides of the metal housing 1 respectively, a base plate 5 is arranged at the bottom of the metal housing 1, bolts 7 are arranged on the base plate 5, and a stationary base 6 is fixedly mounted on the base plate 5 by means of the bolts 7.

In use, the stationary base 6 is fixedly mounted on a racing car, and the base plate 5 is detachably mounted on the stationary base 6 by means of the bolts 7 or other fixing structures.

In specific use of the air and liquid cooling device for racing drivers provided by this embodiment, the compressor 3 compresses the refrigerant to make the refrigerant in a high-temperature and high-pressure state; then, the refrigerant is delivered into the condenser 4 to be cooled by discharging air to the outside by means of the condenser fans 13, such that the temperature of the refrigerant is decreased; the low-temperature refrigerant flows through the liquid reservoir 8 to transmit the low temperature to the liquid in the liquid reservoir 8, such that the temperature of the liquid in the liquid reservoir 8 is decreased, the liquid in the liquid reservoir 8 turns into low-temperature liquid, and the refrigerant flows back into the compressor 3 for next circulation; the water outlet tube of the first water pump 9 is connected to the external liquid-cooled suit, an air inlet in a helmet is connected to the exhaust port 14 of the blower 12, the first water pump 9 pumps the liquid from the liquid reservoir 8 into the liquid-cooled suit worn by a human, and then the liquid flows back into the liquid reservoir 8 for continuous circulation, such that a water cooling effect is realized; the second water pump 11 pumps the liquid from the liquid reservoir 11 into the liquid circulation radiator 10, flowing air around is cooled by means of the liquid circulation radiator 10, the blower 12 sucks air from the refrigeration surface of the liquid circulation radiator 10 and delivers the cold air into the helmet, and liquid discharged from the liquid circulation radiator 10 flows back into the liquid reservoir 8 again for continuous circulation, such that an air cooling effect is realized.

Although the present disclosure is described in detail with reference to the above embodiments, those ordinarily skilled in the art may still make modifications to the technical solutions in the above embodiments or make equivalent substitutions to part of the technical features in the embodiments. Any modifications, equivalent substitutions and improvements made on the basis of the spirit and principle of the present disclosure should fall within the protection scope of the present disclosure.

What is claimed is:

1. An air and liquid cooling device for racing drivers, comprising a metal housing (1);
wherein:
a compressor (3), a condenser (4), a liquid reservoir (8), a first water pump (9), a liquid circulation radiator (10) and a second water pump (11) are arranged in the metal housing (1); an outlet of the compressor (3) is connected to an inlet of the condenser (4) by means of a copper tube, a condenser fan (13) is mounted on a side of the condenser (4), and an outlet of the condenser (4) is connected to an inlet of the compressor (3) by means of a copper tube;
two water inlets and two water outlets are formed in the liquid reservoir (8), one of the two water outlets in the liquid reservoir (8) communicates with a water inlet tube of the first water pump (9), a water outlet tube of the first water pump (9) extends to an outside, the other water outlet in the liquid reservoir (8) communicates with a water inlet tube of the second water pump (11), a water outlet tube of the second water pump (11) communicates with the liquid circulation radiator (10), and a water outlet tube of the liquid circulation radiator (10) communicates with one of the two water inlets in the liquid reservoir (8);
a blower (12) is mounted on a refrigeration surface of the liquid circulation radiator (10); a mainboard (2), an exhaust port (14) and a water filling port (15) are arranged at a top of the metal housing (1); the mainboard (2) comprises a compressor control panel, a liquid cooling control panel and an air cooling control panel; an air outlet of the blower (12) communicates with the exhaust port (14); the water filling port (15) communicates with a top of the liquid reservoir (8).

2. The air and liquid cooling device for racing drivers according to claim 1, wherein the compressor control panel is electrically connected to the compressor (3), the liquid cooling control panel is electrically connected to the first water pump (9), and the air cooling control panel is electrically connected to the second water pump (11) and the blower (12).

3. The air and liquid cooling device for racing drivers according to claim 1, wherein the metal housing (1) is made from aluminum alloy.

4. The air and liquid cooling device for racing drivers according to claim 1, wherein a power interface and a data interface are arranged on two sides of the metal housing (1) respectively.

5. The air and liquid cooling device for racing drivers according to claim 1, wherein a base plate (5) is arranged at a bottom of the metal housing (1), bolts (7) are arranged on the base plate (5), and a stationary base (6) is fixedly mounted on the base plate (5) by means of the bolts (7).

6. The air and liquid cooling device for racing drivers according to claim 1, wherein the copper tubes between the condenser (4) and the compressor (3) penetrate through the liquid reservoir (8).

7. The air and liquid cooling device for racing drivers according to claim 1, wherein an air inlet of the blower (12) corresponds to the liquid circulation radiator (10).
